(19) United States
(12) Patent Application Publication
(10) Pub. No.: US 2026/0057751 A1
(43) Pub. Date: Feb. 26, 2026

(54) IMAGE RECOGNITION APPARATUS, SYSTEM, VEHICLE, NON-TRANSITORY COMPUTER READABLE MEDIUM, AND IMAGE RECOGNITION METHOD

(71) Applicant: TOYOTA JIDOSHA KABUSHIKI KAISHA, Toyota-shi (JP)

(72) Inventor: Masayuki Yamazaki, Yokohama-shi (JP)

(73) Assignee: TOYOTA JIDOSHA KABUSHIKI KAISHA, Toyota-shi (JP)

(21) Appl. No.: 19/251,898

(22) Filed: Jun. 27, 2025

(30) Foreign Application Priority Data
Aug. 26, 2024 (JP) 2024-144587

(51) Int. Cl. G08B 13/196; G06V 10/26; G06V 20/52; G06V 20/59; G06V 40/20

(52) U.S. Cl. CPC G08B 13/1961; G06V 10/273; G06V 20/52; G06V 20/59; G06V 40/23

(57) ABSTRACT

An image recognition apparatus includes a controller configured to acquire an image of space containing a specific area from an imaging apparatus that captures the image, set, in the acquired image, a frame enclosing a person present in the space, identify a region corresponding to the person, at least within the frame in the image, and output an area intrusion notification upon detecting overlap in the image between the identified region and the specific area.

### CROSS-REFERENCE TO RELATED APPLICATION

This application claims priority to Japanese Patent Application No. 2024-144587 filed on Aug. 26, 2024, the entire contents of which are incorporated herein by reference.

### TECHNICAL FIELD

The present disclosure relates to an image recognition apparatus, a system, a vehicle, a program, and an image recognition method.

### BACKGROUND

Patent Literature (PTL) 1 discloses a work vehicle that sets a boundary line indicating the boundary of a dangerous area in a captured image of a work area, and identifies a person image by enclosing the person image with a frame. When it is determined that part of the frame has crossed the boundary line toward the dangerous area, the work vehicle stops the execution of work, such as loading dust, or issues a warning.

### CITATION LIST

### Patent Literature

PTL 1: JP 2022-088127 A

### SUMMARY

Depending on the installation location or type of a camera, such as when images are captured with a fish-eye lens from overhead, a frame enclosing a person may occupy a large area in an image, and part of the frame may cross a boundary line toward a dangerous area in spite of the fact that the person is not present in the dangerous area. In such a case, in conventional technology, it may be erroneously determined that the person has entered the dangerous area.

It would be helpful to reduce the possibility of erroneous determination that a person has entered a specific area.

An image recognition apparatus according to the present disclosure includes a controller configured to:
acquire an image of space containing a specific area, from an imaging apparatus that captures the image;
set, in the acquired image, a frame enclosing a person present in the space;
identify a region corresponding to the person, at least within the frame in the image; and
output an area intrusion notification upon detecting overlap in the image between the identified region and the specific area.

An image recognition method according to the present disclosure includes:
capturing, by an imaging apparatus, an image of space containing a specific area;
setting, by an image recognition apparatus, in the image, a frame enclosing a person present in the space;
identifying, by the image recognition apparatus, a region corresponding to the person, at least within the frame in the image; and
outputting, by the image recognition apparatus, an area intrusion notification upon detecting overlap in the image between the identified region and the specific area.

According to the present disclosure, it is possible to reduce the possibility of erroneous determination that the person has entered the specific area.

### BRIEF DESCRIPTION OF THE DRAWINGS

In the accompanying drawings:

FIG. 1 is a diagram illustrating a configuration of a vehicle according to an embodiment of the present disclosure;

FIG. 2 is a diagram illustrating an example of setting, in an image of space containing a specific area, a frame enclosing a person present in the space;

FIG. 3 is a diagram illustrating an example of identifying, in the same image as FIG. 2, a region corresponding to the person at least within the frame;

FIG. 4 is a block diagram illustrating a configuration of an image recognition apparatus according to the embodiment of the present disclosure; and

FIG. 5 is a flowchart illustrating operations of the image recognition apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

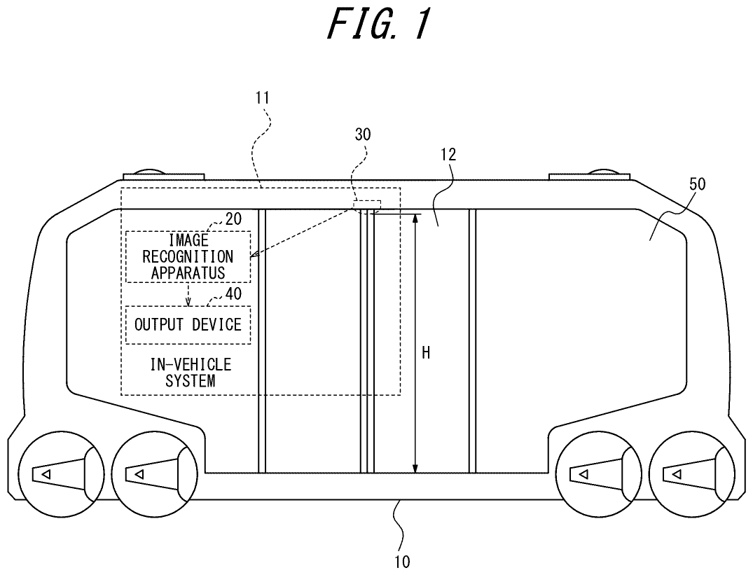

A configuration of a vehicle 10 according to the present embodiment will be described with reference to FIG. 1.

The vehicle 10 may be used for any purpose. In the present embodiment, the vehicle 10 is used to transport passengers and operates as a bus, for example. The vehicle 10 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 10 may be driven by a driver, or the driving may be automated at any level. The automation level is, for example, any one of Level 1 to Level 5 according to the level classification defined by SAE. The name “SAE” is an abbreviation of Society of Automotive Engineers. The vehicle 10 may be a MaaS-dedicated vehicle. The term “MaaS” is an abbreviation of Mobility as a Service.

The vehicle 10 is provided with an in-vehicle system 11. The in-vehicle system 11 includes an image recognition apparatus 20 and an imaging apparatus 30. In the present embodiment, the in-vehicle system 11 may further include an output device 40, which is not essential though. The image recognition apparatus 20 can communicate with the imaging apparatus 30 and the output device 40 directly or via a network such as a LAN. The term “LAN”is an abbreviation of local area network.

The image recognition apparatus 20 is a computer that has an image recognition function. The image recognition apparatus 20 may be installed at any location in the vehicle 10.

The imaging apparatus 30 is, for example, an RGB camera or an infrared camera. In the present embodiment, the imaging apparatus 30 is a fish-eye camera or a 360-degree camera. The imaging apparatus 30 may be installed at any location from which space 50 can be imaged. In the present embodiment, the space 50 is interior space of the vehicle 10, and the imaging apparatus 30 is at a height of a top end of a door 12, for the passengers to get in and out, or higher. The height H from a floor of the vehicle 10 to the imaging apparatus 30 is preferably a height that allows imaging of standing passengers from overhead, and is 2.1 meters, for example. The imaging apparatus 30 may be installed on a low ceiling inside the vehicle 10.

The output device 40 is, for example, a display or a speaker. The display is, for example, an LCD or an organic EL display. The term “LCD” is an abbreviation of liquid crystal display. The term “EL” is an abbreviation of electro luminescent. When the output device 40 is a display, the output device 40 may be installed, in the vehicle 10, at any location that is visible from the passengers. When the output device 40 is a speaker, the output device 40 may be installed, in the vehicle 10, at any location from which sound can reach the passengers.

An outline of the present embodiment will be described with reference to FIGS. 1 to 3.

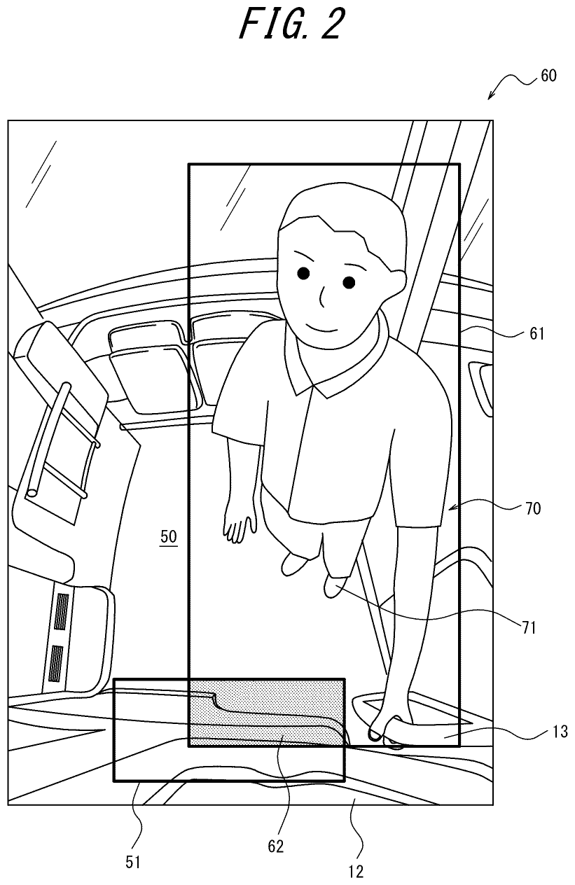

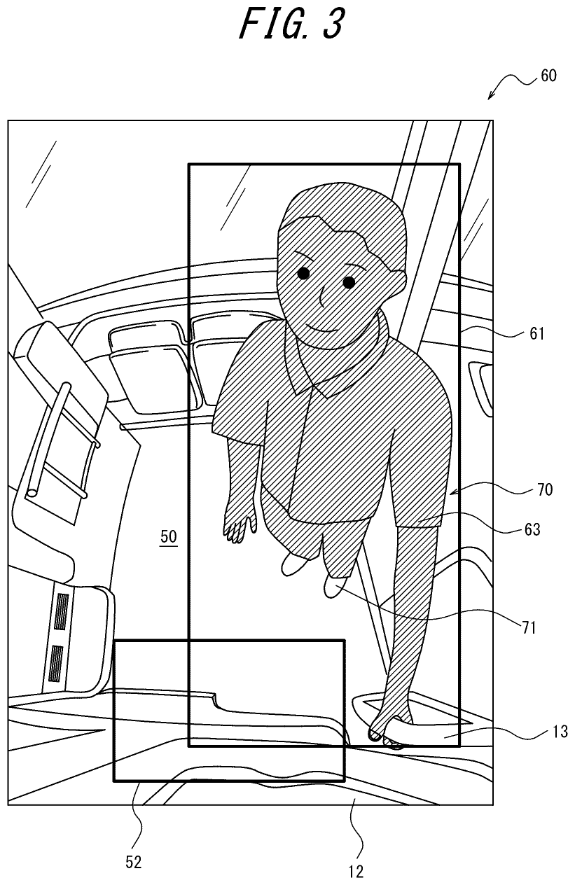

The imaging apparatus 30 captures an image 60 of the space 50. The space 50 contains a specific area 51. As illustrated in FIG. 2, the image recognition apparatus 20 sets, in the image 60, a frame 61 that encloses a person 70 present in the space 50. For example, a bounding box is set as the frame 61. As a specific example regarding the setting of the bounding box, it is conceivable that the location of the person 70 is identified in the image 60 using a deep learning model such as YOLO or SSD, and a rectangular frame, which is defined by upper left and lower right coordinate points of the person 70, is drawn around the person 70 in the image 60. The term “YOLO” is an abbreviation of you only look once. The term “SSD” is an abbreviation of single shot multibox detector. The image recognition apparatus 20 calculates the ratio of overlap 62 in the image 60 between the set frame 61 and the specific area 51. Upon determining that the calculated ratio is less than a threshold value, as illustrated in FIG. 3, the image recognition apparatus 20 identifies a region 63 corresponding to the person 70, at least within the frame 61 in the image 60. The region 63 is identified, for example, by segmentation using deep learning. As a specific example regarding segmentation, it is conceivable that which class each pixel at least within the frame 61 in the image 60 belongs to is predicted using a deep learning model such as U-Net or DeepLab, and pixels belonging to a “person” class are extracted as one segment. Upon detecting overlap in the image 60 between the identified region 63 and the specific area 51, the image recognition apparatus 20 outputs an area intrusion notification.

Depending on the installation location or type of the imaging apparatus 30, such as when the image is captured with a fish-eye lens from overhead, the frame 61 enclosing the person 70 may occupy a larger area in the image 60 and overlap with the specific area 51, in spite of the fact that the person 70 is not present in the specific area 51. For example, when the image 60 is captured with the fish-eye lens, the frame 61 tends to be larger because the outline of the person 70 is distorted. In such a case, in the present embodiment, the region 63 corresponding to the person 70 is identified by secondary processing, which is more precise than the setting of the frame 61, as primary processing, when the ratio of the overlap 62 is less than the threshold value. Whether the person 70 has entered the specific area 51 is then determined according to the overlap between the region 63 and the specific area 51. Therefore, according to the present embodiment, it is possible to reduce the possibility of erroneous determination that the person 70 has entered the specific area 51. As a variation, the image recognition apparatus 20 may identify the region 63 corresponding to the person 70, regardless of whether the ratio of the overlap 62 is less than the threshold value. In such a variation, the image recognition apparatus 20 does not have to calculate the ratio of the overlap 62.

In the present embodiment, the region 63 is smaller than the frame 61. According to the present embodiment, when the ratio of the overlap 62 between the frame 61 and the specific area 51 is less than the threshold value, a smaller area than the frame 61 is identified as the region 63, thus preventing erroneous determination that the person 70 has entered the specific area 51, in spite of the fact that the person 70 is not present in the specific area 51.

In the present embodiment, operation time required to identify the region 63 is longer than operation time required to set the frame 61. According to the present embodiment, when the ratio of the overlap 62 between the frame 61 and the specific area 51 is equal to or greater than the threshold value, the region 63 does not have to be identified, thus preventing an increase in the operation time.

In the present embodiment, operation cost required to identify the region 63 is greater than operation cost required to set the frame 61. According to the present embodiment, when the ratio of the overlap 62 between the frame 61 and the specific area 51 is equal to or greater than the threshold value, the region 63 does not have to be identified, thus preventing an increase in the operation cost.

In the present embodiment, upon determining that the ratio of the overlap 62 between the frame 61 and the specific area 51 is equal to or greater than the threshold value, the image recognition apparatus 20 outputs the area intrusion notification, without identifying the region 63. Therefore, according to the present embodiment, when the ratio of the overlap 62 between the frame 61 and the specific area 51 is equal to or greater than the threshold value, the area intrusion notification can be output earlier.

In the present embodiment, when identifying the region 63, as illustrated in FIG. 3, the image recognition apparatus 20 sets an enlarged area 52 by enlarging the specific area 51 in the image 60. Upon detecting overlap in the image 60 between the identified region 63 and the enlarged area 52, the image recognition apparatus 20 outputs the area intrusion notification. In the present embodiment, the specific area 51 is an area in which the door 12 is located. For example, it is conceivable that the frame 61 contains shoes 71, while the region 63 does not contain the shoes 71, and that the enlarged area 52 is enlarged from the specific area 51 by the height of an ankle. Alternatively, it is also conceivable that the frame 61 contains a lower half of a body, while the region 63 does not contain the lower half of the body, and that the enlarged area 52 is enlarged from the specific area 51 by the height of a waist. According to these examples, since the hard-to-detect area such as the shoes 71 is not contained, it is possible to prevent erroneous determination that the person 70 is not standing near the door 12, in spite of the fact that the person 70 is standing near the door 12. In the present embodiment, a handrail 13 is provided around the door 12. For example, it is conceivable that the frame 61 contains hands, while the region 63 does not contain the hands, and that the specific area 51 is set not to contain the handrail 13 and the enlarged area 52 is enlarged to contain the handrail 13. According to this example, it is possible to prevent erroneous determination that the person 70 is standing near the door 12, in spite of the fact that the person 70 is only reaching out and grasping the handrail 13 and not standing near the door 12. To obtain the enlarged area 52, the specific area 51 may be simply enlarged by a certain percentage, or may be enlarged according to the location of the handrail 13.

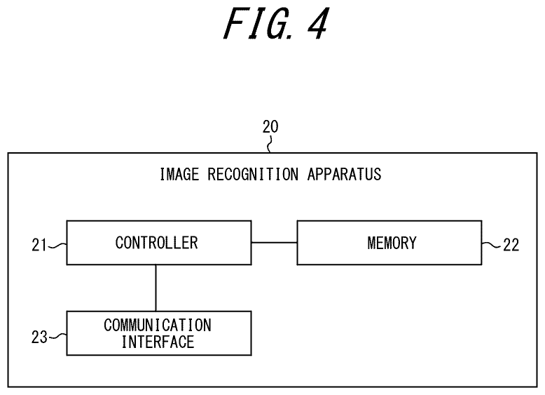

A configuration of the image recognition apparatus 20 according to the present embodiment will be described with reference to FIG. 4.

The image recognition apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the image recognition apparatus 20 while controlling components of the image recognition apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the image recognition apparatus 20 and information obtained by the operations of the image recognition apparatus 20.

The communication interface 23 includes at least one communication module. The communication module is, for example, an interface compatible with a wired LAN communication standard such as Ethernet® (Ethernet is a registered trademark in Japan, other countries, or both) or a wireless LAN communication standard such as IEEE 802.11. The name “IEEE” is an abbreviation of Institute of Electrical and Electronics Engineers. The communication module may be, for example, an interface compliant with another standard such as USB, HDMI® (HDMI is a registered trademark in Japan, other countries, or both), or Bluetooth® (Bluetooth is a registered trademark in Japan, other countries, or both). The term “USB” is an abbreviation of Universal Serial Bus. The term “HDMI®” is an abbreviation of High-Definition Multimedia Interface. The communication interface 23 communicates with the imaging apparatus 30 and the output device 40. The communication interface 23 may communicate with the door 12. The communication interface 23 receives information to be used for the operations of the image recognition apparatus 20 and transmits information obtained by the operations of the image recognition apparatus 20.

The functions of the image recognition apparatus 20 are realized by execution of a program according to the present embodiment by a processor serving as the controller 21. That is, the functions of the image recognition apparatus 20 are realized by software. The program causes a computer to execute the operations of the image recognition apparatus 20, thereby causing the computer to function as the image recognition apparatus 20. That is, the computer executes the operations of the image recognition apparatus 20 in accordance with the program to thereby function as the image recognition apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program”in this context.

Some or all of the functions of the image recognition apparatus 20 may be realized by a programmable circuit or a dedicated circuit serving as the controller 21. That is, some or all of the functions of the image recognition apparatus 20 may be realized by hardware.

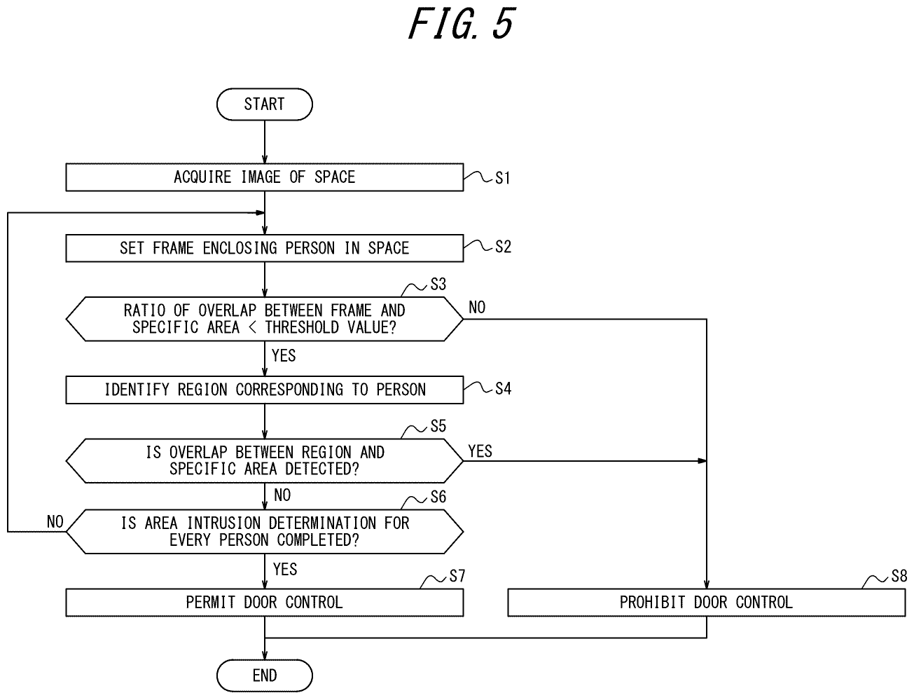

Operations of the image recognition apparatus 20 according to the present embodiment will be described with reference to FIG. 5. The operations described below correspond to an image recognition method according to the present embodiment. In other words, the image recognition method according to the present embodiment includes steps S1 to S8 illustrated in FIG. 5.

In S1, the controller 21 acquires, from the imaging apparatus 30, an image 60 of the space 50 containing the specific area 51. Specifically, the controller 21 receives the image 60 from the imaging apparatus 30 via the communication interface 23.

In S2, the controller 21 sets, in the image 60 acquired in S1, a frame 61 that encloses a person 70 present in the space 50. As a method for setting the frame 61, a known method such as a bounding box can be used.

In S3, the controller 21 calculates, in the image 60 acquired in S1, the ratio of overlap 62 between the frame 61 set in S2 and the specific area 51. The controller 21 determines whether the calculated ratio is less than a threshold value. The threshold value is, for example, 1/9 of the area of the frame 61, but may be adjusted according to the area of the specific area 51. Specifically, the smaller the area of the specific area 51, the smaller value the threshold value may be set to. When the ratio of the overlap 62 between the frame 61 and the specific area 51 is determined to be less than the threshold value, the step S4 is performed. On the other hand, when the ratio of the overlap 62 between the frame 61 and the specific area 51 is determined to be equal to or greater than the threshold value, the step S8 is performed.

In S4, the controller 21 identifies a region 63 corresponding to the person 70, at least within the frame 61 of the image 60 acquired in S1. Specifically, the controller 21 identifies the region 63 by classifying pixels at least within the frame 61 of the image 60 into the region 63 and one or more other types of regions. As a method for classifying the pixels, a known method such as segmentation can be used.

In the present embodiment, when identifying the region 63, the controller 21 sets an enlarged area 52 by enlarging the specific area 51 in the image 60. Specifically, the controller 21 sets the enlarged area 52 by enlarging the specific area 51 by a certain ratio. For example, the controller 21 sets the enlarged area 52 by simply enlarging the specific area 51 by a certain percentage. Alternatively, the controller 21 may set the enlarged area 52 by enlarging the specific area 51 by an amount of a height corresponding to a specific part and a lower part of the person 70. In such an example, the controller 21, when setting the frame 61, includes the frame 61 the specific part and the lower part of the person 70, and when identifying the region 63, excludes from the region 63 the specific part and the lower part of the person 70. The specific part is, for example, an ankle or a waist. In other words, the controller 21 may set the frame 61 to contain shoes 71 and set the region 63 not to contain the shoes 71, and set the enlarged area 52 by enlarging the specific area 51 by an amount of the height of the ankle. The controller 21 may set the frame 61 to contain a lower half of a body and set the region 63 not to contain the lower half of the body, and set the enlarged area 52 by enlarging the specific area 51 by an amount of the height of the waist. Alternatively, the controller 21 may set the enlarged area 52 by enlarging the specific area 51 according to the location of the handrail 13. In such an example, the specific area 51 may not contain the location of the handrail 13, and the enlarged area 52 may contain the location of the handrail 13. For example, the controller 21 may set the frame 61 to contain hands, set the region 63 not to contain the hands, set the specific area 51 not to contain the handrail 13, and set the enlarged area 52 by enlarging the specific area 51 to contain the handrail 13.

In S5, the controller 21 determines, in the image 60 acquired in S1, the presence or absence of overlap between the region 63 identified in S4 and the specific area 51. When no overlap between the region 63 and the specific area 51 is detected, the step S6 is performed. On the other hand, when the overlap between the region 63 and the specific area 51 is detected, the step S8 is performed.

In the present embodiment, the controller 21 determines, in the image 60, the presence or absence of overlap between the region 63 and the enlarged area 52. When no overlap between the region 63 and the enlarged area 52 is detected, the step S6 is performed. On the other hand, when the overlap between the region 63 and the enlarged area 52 is detected, the step S8 is performed.

In S6, the controller 21 determines whether the steps from S2 and later have been performed for every person in the space 50. When it is determined that the steps from S2 and later have not yet been performed for every person, the steps from S2 and later are performed again. On the other hand, when it is determined that the steps from S2 and later have already been performed for every person, the step S7 is performed.

In S7, the controller 21 permits the door 12 to open by outputting an area non-intrusion notification. Specifically, the controller 21 permits the door 12 to open by transmitting a door control signal corresponding to the area non-intrusion notification, via the communication interface 23. Alternatively, the controller 21 may transmit a message corresponding to the area non-intrusion notification, such as “The door opens”, via the communication interface 23, and cause the output device 40 to display the message on a screen or output the message audibly.

In S8, the controller 21 prohibits the door 12 from opening by outputting an area intrusion notification. Specifically, the controller 21 prohibits the door 12 from opening by transmitting a door control signal corresponding to the area intrusion notification, via the communication interface 23. Alternatively, the controller 21 may transmit a message corresponding to the area intrusion notification, such as “Please stand away from the door because it is dangerous”, via the communication interface 23, and cause the output device 40 to display the message on the screen or output the message audibly.

In the present embodiment, with the operations described above, it is possible to determine, with high accuracy in a short time and at low cost, whether passengers who are on board the vehicle 10 in postures grasping handrails 13, e.g., with only arms sticking out, are standing near the door 12, using the imaging apparatus 30, such as an RGB camera, from an overlooking position, for example. In the present embodiment, the degree of overlap between the person detection rectangle and the target area is determined. When the degree of overlap is small, the overlap between the more detailed segmentation region and the target area is determined, which allows area intrusion determination with high accuracy while reducing operation time and operation cost. According to the present embodiment, even when it is difficult to install many devices on the ceiling of the vehicle 10, the accuracy of the determination can be improved without installing multiple cameras.

The present disclosure is not limited to the embodiment described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.
[Appendix 1] An image recognition apparatus comprising a controller configured to:
   acquire an image of space containing a specific area, from an imaging apparatus that captures the image;
   set, in the acquired image, a frame enclosing a person present in the space;
   identify a region corresponding to the person, at least within the frame in the image; and output an area intrusion notification upon detecting overlap in the image between the identified region and the specific area.
[Appendix 2] The image recognition apparatus according to appendix 1, wherein the region is smaller than the frame.
[Appendix 3] The image recognition apparatus according to appendix 1 or 2, wherein the controller is configured to identify the region by classifying pixels at least within the frame in the image into the region and one or more other types of regions.
[Appendix 4] The image recognition apparatus according to any one of appendices 1 to 3, wherein operation time or operation cost required to identify the region is greater than operation time or operation cost required to set the frame.
[Appendix 5] The image recognition apparatus according to any one of appendices 1 to 4, wherein the controller is configured to:
   calculate a ratio of overlap in the image between the set frame and the specific area;
   upon determining that the calculated ratio is less than a threshold value, identify the region corresponding to the person at least within the frame in the image; and
   upon determining that the ratio is equal to or greater than the threshold value, output the area intrusion notification, without identifying the region.
[Appendix 6] The image recognition apparatus according to any one of appendices 1 to 5, wherein the controller is configured to:
   when identifying the region, set an enlarged area by enlarging the specific area in the image; and
   output the area intrusion notification upon detecting overlap in the image between the region and the enlarged area.
[Appendix 7] The image recognition apparatus according to appendix 6, wherein the controller is configured to set the enlarged area by enlarging the specific area by a certain ratio.
[Appendix 8] The image recognition apparatus according to appendix 6, wherein the controller is configured to:
   when setting the frame, include in the frame a specific part and a lower part of the person;
   when identifying the region, exclude from the region the specific part and the lower part of the person; and
   set the enlarged area by enlarging the specific area by an amount of a height corresponding to the specific part and the lower part of the person.
[Appendix 9] The image recognition apparatus according to appendix 8, wherein the specific part is an ankle or a waist.
[Appendix 10] The image recognition apparatus according to appendix 6, wherein
   the space is interior space of a vehicle that transports a passenger,
   the specific area is an area in which a door is located for the passenger to get in and out, and
   the controller is configured to set the enlarged area by enlarging the specific area according to a location of a handrail provided around the door.
[Appendix 11] The image recognition apparatus according to appendix 10, wherein
   the specific area does not contain the location of the handrail, and
   the enlarged area contains the location of the handrail.
[Appendix 12] The image recognition apparatus according to any one of appendices 1 to 9, wherein
   the space is interior space of a vehicle that transports a passenger,
   the specific area is an area in which a door is located for the passenger to get in and out, and
the imaging apparatus is installed at a height of a top end of the door or higher.
[Appendix 13] The image recognition apparatus according to appendix 12, wherein the imaging apparatus is a fish-eye camera.
[Appendix 14] The image recognition apparatus according to any one of appendices 1 to 9, wherein
   the space is interior space of a vehicle that transports a passenger,
   the specific area is an area in which a door is located for the passenger to get in and out, and
   the controller is configured to prohibit the door from opening, by outputting the area intrusion notification.
[Appendix 15] A system comprising:
   the image recognition apparatus according to any one of appendices 1 to 14; and
   the imaging apparatus.
[Appendix 16] A vehicle comprising the system according to appendix 15.
[Appendix 17] A program configured to cause a computer to function as the image recognition apparatus according to any one of appendices 1 to 14.
[Appendix 18] An image recognition method comprising:
   capturing, by an imaging apparatus, an image of space containing a specific area;
   setting, by an image recognition apparatus, in the image, a frame enclosing a person present in the space;
   identifying, by the image recognition apparatus, a region corresponding to the person, at least within the frame in the image; and
   outputting, by the image recognition apparatus, an area intrusion notification upon detecting overlap in the image between the identified region and the specific area.
[Appendix 19] The image recognition method according to appendix 18, further comprising:
   calculating, by the image recognition apparatus, a ratio of overlap in the image between the set frame and the specific area;
   upon determining that the calculated ratio is less than a threshold value, identifying, by the image recognition apparatus, the region corresponding to the person at least within the frame in the image; and
   upon determining that the ratio is equal to or greater than the threshold value, outputting, by the image recognition apparatus, the area intrusion notification, without identifying the region.
[Appendix 20] The image recognition method according to appendix 18 or 19, further comprising, when identifying the region, setting, by the image recognition apparatus, an enlarged area by enlarging the specific area in the image,
   wherein the outputting of the area intrusion notification is performed upon detecting, by the image recognition apparatus, overlap in the image between the region and the enlarged area.

1. An image recognition apparatus comprising a controller configured to:
acquire an image of space containing a specific area, from an imaging apparatus that captures the image;
set, in the acquired image, a frame enclosing a person present in the space;
identify a region corresponding to the person, at least within the frame in the image; and
output an area intrusion notification upon detecting overlap in the image between the identified region and the specific area.

2. The image recognition apparatus according to claim 1, wherein the region is smaller than the frame.

3. The image recognition apparatus according to claim 1, wherein the controller is configured to identify the region by classifying pixels at least within the frame in the image into the region and one or more other types of regions.

4. The image recognition apparatus according to claim 1, wherein operation time or operation cost required to identify the region is greater than operation time or operation cost required to set the frame.

5. The image recognition apparatus according to claim 1, wherein the controller is configured to:
calculate a ratio of overlap in the image between the set frame and the specific area;
upon determining that the calculated ratio is less than a threshold value, identify the region corresponding to the person at least within the frame in the image;
and upon determining that the ratio is equal to or greater than the threshold value, output the area intrusion notification, without identifying the region.

6. The image recognition apparatus according to claim 1, wherein the controller is configured to:
when identifying the region, set an enlarged area by enlarging the specific area in the image; and
output the area intrusion notification upon detecting overlap in the image between the region and the enlarged area.

7. The image recognition apparatus according to claim 6, wherein the controller is configured to set the enlarged area by enlarging the specific area by a certain ratio.

8. The image recognition apparatus according to claim 6, wherein the controller is configured to:
when setting the frame, include in the frame a specific part and a lower part of the person;
when identifying the region, exclude from the region the specific part and the lower part of the person; and
set the enlarged area by enlarging the specific area by an amount of a height corresponding to the specific part and the lower part of the person.

9. The image recognition apparatus according to claim 8, wherein the specific part is an ankle or a waist.

10. The image recognition apparatus according to claim 6, wherein
the space is interior space of a vehicle that transports a passenger,
the specific area is an area in which a door is located for the passenger to get in and out, and
the controller is configured to set the enlarged area by enlarging the specific area according to a location of a handrail provided around the door.

11. The image recognition apparatus according to claim 10, wherein the specific area does not contain the location of the handrail, and the enlarged area contains the location of the handrail.

12. The image recognition apparatus according to claim 1, wherein
the space is interior space of a vehicle that transports a passenger,
the specific area is an area in which a door is located for the passenger to get in and out, and
the imaging apparatus is installed at a height of a top end of the door or higher.

13. The image recognition apparatus according to claim 12, wherein the imaging apparatus is a fish-eye camera.

14. The image recognition apparatus according to claim 1, wherein
the space is interior space of a vehicle that transports a passenger,
the specific area is an area in which a door is located for the passenger to get in and out, and
the controller is configured to prohibit the door from opening, by outputting the area intrusion notification.

15. A system comprising:
the image recognition apparatus according to claim 1; and
the imaging apparatus.

16. A vehicle comprising the system according to claim 15.

17. A non-transitory computer readable medium storing a program configured to cause a computer to function as the image recognition apparatus according to claim 1.

18. An image recognition method comprising:
capturing, by an imaging apparatus, an image of space containing a specific area;
setting, by an image recognition apparatus, in the image, a frame enclosing a person present in the space;
identifying, by the image recognition apparatus, a region corresponding to the person, at least within the frame in the image; and
outputting, by the image recognition apparatus, an area intrusion notification upon detecting overlap in the image between the identified region and the specific area.

19. The image recognition method according to claim 18, further comprising:
calculating, by the image recognition apparatus, a ratio of overlap in the image between the set frame and the specific area;
upon determining that the calculated ratio is less than a threshold value, identifying, by the image recognition apparatus, the region corresponding to the person at least within the frame in the image; and
upon determining that the ratio is equal to or greater than the threshold value, outputting, by the image recognition apparatus, the area intrusion notification, without identifying the region.

20. The image recognition method according to claim 18, further comprising, when identifying the region, setting, by the image recognition apparatus, an enlarged area by enlarging the specific area in the image,
wherein the outputting of the area intrusion notification is performed upon detecting, by the image recognition apparatus, overlap in the image between the region and the enlarged area.
